(19) United States
(12) Patent Application Publication
(10) Pub. No.: US 2025/0084204 A1
(43) Pub. Date: Mar. 13, 2025

(54) POLYMER WITH UV-RESPONSIVE SELF-HEALING FUNCTION AND MANUFACTURING METHOD OF THE SAME

(71) Applicant: PUSAN NATIONAL UNIVERSITY INDUSTRY-UNIVERSITY COOPERATION FOUNDATION, Busan (KR)

(72) Inventors: Chae Bin KIM, Busan (KR); Yeomyung Yoon, Busan (KR); Dupyo Jeon, Busan (KR); Gyeong Hwan Choi, Busan (KR)

(73) Assignee: PUSAN NATIONAL UNIVERSITY INDUSTRY-UNIVERSITY COOPERATION FOUNDATION, Busan (KR)

(21) Appl. No.: 18/610,294

(22) Filed: Mar. 20, 2024

(30) Foreign Application Priority Data
Sep. 12, 2023 (KR) 10-2023-0120925

(51) Int. Cl. C08G 59/40; C08G 59/22; C08J 3/24

(52) U.S. Cl. CPC C08G 59/4064; C08G 59/22; C08J 3/246

(57) ABSTRACT

A polymer having a UV-responsive self-healing function at room temperature and its manufacturing method are disclosed herein. More specifically, the solid dynamic crosslinked polymer with a UV-responsive self-healing function is capable of being repaired and reprocessed through a dynamic exchange reaction of disulfide induced under exposure to UV radiation at ambient temperature when damaged after curing. The novel polymer with a UV-responsive self-healing function is capable of self-healing simply through UV exposure at ambient temperature. Therefore, it can be utilized in the recycling of thermosetting resins that are environmentally challenging to recycle in the plastic industry, and furthermore, serve as an alternative to address various environmental issues.

### CROSS-REFERENCE TO RELATED APPLICATION

This application claims priority to Korean Patent Application No. 10-2023-0120925 (filed on Sep. 12, 2023), which is hereby incorporated by reference in its entirety.

### BACKGROUND

The present invention relates to a polymer having a UV-responsive self-healing function at room temperature and its manufacturing method, and more specifically to a polymer with a UV-responsive self-healing function and its manufacturing method, where a solid dynamic crosslinked polymer with a UV-responsive self-healing function is capable of being repaired and reprocessed through a dynamic exchange reaction of disulfide induced under exposure to UV radiation at room temperature when damaged after curing.

The generation and consumption of commonly used plastics in everyday life have consistently increased annually, leading to a rapid rise in the amount of plastic waste. Due to the non-biodegradable nature of landfilling plastic waste, it poses a potential threat to future environmental pollution. Incineration methods release substantial amounts of harmful substances into the atmosphere, contributing to new environmental pollution, and the coastal inflow of the harmful substances is steadily increasing. The improper disposal of plastics, causing ecological threats, has been a persistently emerging environmental issue.

Currently, material recycling is recognized as the most environmentally friendly and low-carbon emission method, involving processes such as sorting, cleaning, and thermal processing to reuse the materials as recycled raw materials.

The restriction on material recycling is significant for thermosetting resins, which are excellent in chemical resistance, mechanical strengths and structural conservation and do not melt under heat, making recycling impractical. Recently, there is growing interest in novel dynamic crosslinked polymers called Covalent Adaptable Networks or CANs, which possesses the advantages of thermosetting resins while allowing for simultaneous thermal processing. This unique feature is achieved by forming a network through dynamic crosslinks between polymer chains.

However, in the case of conventional CANs, the activation of exchange reactions at high temperatures leads to overall heat exposure, resulting in inefficient repair processes and unnecessary energy consumption for localized damage. Moreover, for polymers used in heat-sensitive products, the repair of damage by heating is limited.

Due to these issues, recent research has actively pursued polymers capable of self-healing at ambient temperature. In particular, research on ambient-temperature self-healing using thermoplastic polyurethane (TPU) is ongoing; however, TPU's thermoplastic nature compromises structural stability at high temperatures, presenting limitations in high-temperature applications. Additionally, thermosetting polymers like epoxy excellent in properties such as chemical resistance, mechanical strength, and numerical stability are used in various industries. Nevertheless, these polymers often rely on hydrogen bonds and slow exchange reactions, requiring extended processing times and exhibiting a drawback of approximately 80% lower property recovery rate.

To overcome these challenges, the inventors have developed a method for manufacturing polymers with a UV-responsive self-healing function, induced by a dynamic exchange reaction of disulfide through exposure to UV radiation at ambient temperature, addressing the mentioned issues and completing the invention.

### SUMMARY

The present invention is disclosed to address the above-mentioned issues, and an object of the present invention is to provide a polymer with a UV-responsive self-healing function and its manufacturing method, where a solid dynamic crosslinked polymer with a UV-responsive self-healing function can be repaired and reprocessed through a dynamic exchange reaction of disulfide induced under exposure to UV radiation at ambient temperature when damaged after curing.

The technical challenges that the invention seeks to solve are not limited to those mentioned above, and additional technical challenges not explicitly stated will be readily understood by those skilled in the art in the relevant field from the following disclosure.

The present invention for achieving the above-mentioned object provides a polymer with a UV-responsive self-healing function that comprises a first monomer containing at least two epoxy groups; and a second monomer serving as a curing agent, where the first and second monomers are combined to enable a dynamic exchange reaction of disulfide, allowing for self-healing.

The first monomer comprises at least one selected from the group consisting of bisphenol-based, aminophenol-based, siloxane-based, and alicyclic epoxy resins.

The second monomer, serving as a curing agent containing sulfur, comprises at least one selected from the group consisting of 4-aminophenyl disulfide, 3,3′-dihydroxydiphenyl disulfide, and 4-(2-hydroxyethoxy)phenyl disulfide.

The second monomer is represented by the following chemical formula 1, 2, or 3:

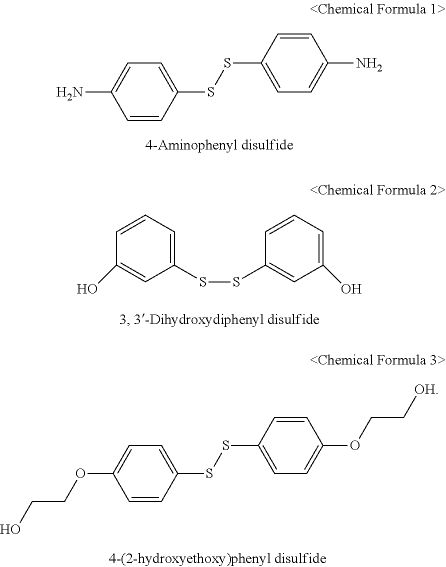 [SMILES: Nc1ccc(SSc2ccc(N)cc2)cc1 ; Oc1cccc(SSc2cccc(O)c2)c1 ; OCCOc1ccc(SSc2ccc(OCCO)cc2)cc1]

The polymer is capable of self-healing through a dynamic exchange reaction of disulfide induced under exposure to UV radiation when damaged even after curing.

The UV radiation has a wavelength of 250 to 260 nm.

The exposure to UV radiation is conducted by irradiating UV radiation with an intensity of 20 to 40 mW/cm² for 5 to 15 minutes at ambient temperature.

The present invention also provides a method for manufacturing a polymer with a UV-responsive self-healing function that comprises: mixing a first monomer and a second monomer and heating the mixture; placing the heated mixture into a preheated mold; degassing the mixture placed in the mold through vacuum substitution; and heating the degassed mixture to obtain a cured polymer.

The first monomer is a monomer containing at least two epoxy groups and comprises at least one selected from the group consisting of bisphenol-based, aminophenol-based, siloxane-based, and alicyclic epoxy resins.

The second monomer, serving as a curing agent containing sulfur, comprises at least one selected from the group consisting of 4-aminophenyl disulfide, 3,3′-dihydroxydiphenyl disulfide, and 4-(2-hydroxyethoxy)phenyl disulfide.

The second monomer is represented by the following chemical formula 1, 2, or 3.

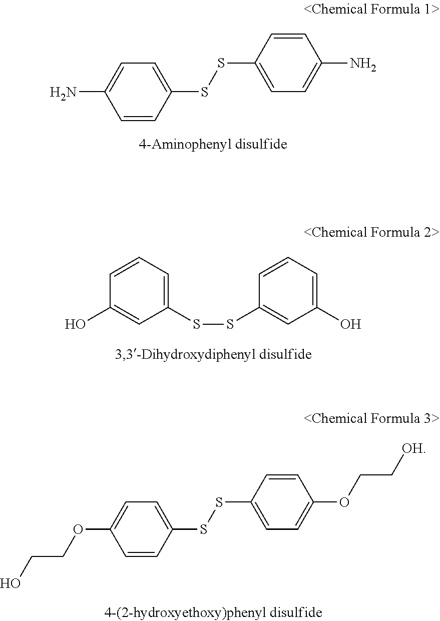 [SMILES: Nc1ccc(SSc2ccc(N)cc2)cc1 ; Oc1cccc(SSc2cccc(O)c2)c1 ; OCCOc1ccc(SSc2ccc(OCCO)cc2)cc1]

The step of mixing the first and second monomers and heating the mixture is performed at a temperature of 95 to 105° C. for 5 to 15 minutes.

The step of degassing the mixture placed in the mold through vacuum substitution is performing degassing through vacuum substitution for 10 to 20 minutes.

The step of heating the degassed mixture to obtain a cured polymer is heating the mixture at an elevated temperature of 140 to 160° C. for 9 to 11 hours to obtain a cured polymer.

The polymer with a UV-responsive self-healing function according to the present invention can be repaired and reprocessed through a dynamic exchange reaction of disulfide induced under exposure to UV radiation at ambient temperature when damaged after curing. Therefore, it can be utilized in the recycling of thermosetting resins that are environmentally challenging to recycle in the plastic industry.

Furthermore, it could serve as an alternative to address various environmental issues.

### BRIEF DESCRIPTION OF THE DRAWINGS

FIG. 1 is a reaction equation showing the dynamic disulfide exchange reaction induced by UV exposure on the polymer with a UV-responsive self-healing function manufactured according to an embodiment of the present invention.

FIG. 2 is a graph showing the degree of curing (or gel content) over time for the polymer with a UV-responsive self-healing function manufactured according to an embodiment of the present invention.

FIG. 3 is a graph depicting the ATR-FTIR analysis of the monomers and cured polymer with a UV-responsive self-healing function manufactured according to an embodiment of the present invention.

FIG. 4 is a graph analyzing the thermo-mechanical properties of the polymer with a UV-responsive self-healing function manufactured according to an embodiment of the present invention.

FIG. 5 is a graph comparing the stress-relaxation behavior of the polymer with an UV-responsive self-healing function manufactured according to an embodiment of the present invention, before and during UV exposure at ambient temperature.

FIG. 6 is a graph showing the stress-relaxation analysis measured at various temperatures during UV exposure for a polymer with an UV-responsive self-healing function manufactured according to an embodiment of the present invention.

FIG. 7 depicts a polymer with a UV-responsive self-healing function manufactured according to an embodiment of the present invention, undergoing repair and reprocessing through UV exposure at ambient temperature.

### DETAILED DESCRIPTION

The terms used in this specification will be briefly explained prior to a detailed description of the present invention.

The terms used in the present invention have been chosen with consideration for the functionality in the present widely used common terms, relevant to those skilled in the art. However, these may vary based on the intent of the practitioner, precedents, emergence of new technologies, and other factors in the field. Therefore, the terms used in the present invention should be defined not merely as nominal designations but based on the meaning they carry and encompassing the overall content of the present invention.

When any part throughout the specification is referred to as “including” or “comprising” a certain component, it means that, unless specifically stated otherwise, it does not exclude other components and may include additional components without expressly excluding others.

The following describes, with reference to the attached drawings, embodiments of the present invention in a field of technology known to those with ordinary skill in the art, so that one skilled in the art can easily carry out the present invention. However, the present invention can be implemented in various forms and is not limited to the embodiments described here.

Specific details, including the problems to be solved by the present invention, means for solving the problems, and the effects of the invention, are included in the following examples and drawings. The advantages and features of the present invention, as well as the methods for achieving them, will become clear by referring to the detailed embodiments provided with the attached drawings.

Hereinafter, the present invention will be described in further detail with reference to the attached drawings.

The present invention provides a polymer with a UV-responsive self-healing function that comprises a first monomer containing at least two epoxy groups; and a second monomer serving as a curing agent, where the first and second monomers are combined to enable a dynamic disulfide exchange reaction, allowing for self-healing.

The first monomer may comprise at least one selected from the group consisting of bisphenol-based, aminophenol-based, siloxane-based, and alicyclic epoxy resins.

The second monomer may serve as a curing agent containing sulfur and comprise at least one selected from the group consisting of 4-aminophenyl disulfide, 3,3′-dihydroxydiphenyl disulfide, and 4-(2-hydroxyethoxy)phenyl disulfide.

The second monomer may be represented by the following chemical formula 1, 2, or 3.

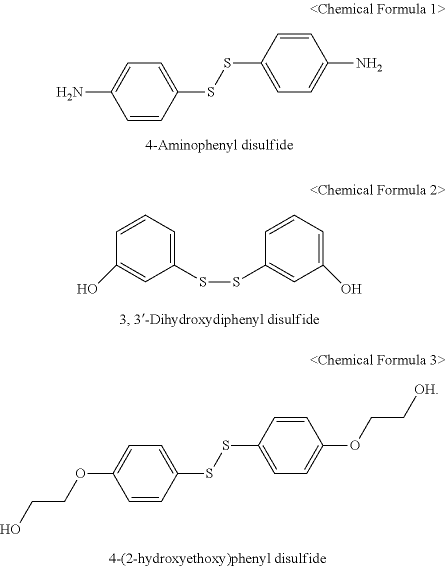 [SMILES: Nc1ccc(SSc2ccc(N)cc2)cc1 ; Oc1cccc(SSc2cccc(O)c2)c1 ; OCCOc1ccc(SSc2ccc(OCCO)cc2)cc1]

The polymer may be capable of self-healing through a dynamic disulfide exchange reaction induced by exposure to UV radiation when damaged even after curing.

The UV radiation preferably has a wavelength of 250 to 260 nm, more preferably 254 nm.

The exposure to UV radiation is preferably conducted by irradiating UV radiation with an intensity of 20 to 40 mW/cm² for 5 to 15 minutes at ambient temperature, more preferably with an intensity of 30 mW/cm² for 10 minutes at ambient temperature.

The energy level when irradiating UV radiation with an intensity of 30 mW/cm² for 10 minutes at ambient temperature may be 18 J/cm².

The present invention also provides a method for manufacturing a polymer with a UV-responsive self-healing function that comprises: mixing a first monomer and a second monomer and heating the mixture; placing the heated mixture into a preheated mold; degassing the mixture placed in the mold through vacuum substitution; and heating the degassed mixture at an elevated temperature to obtain a cured polymer.

Preferably, the first monomer may be a monomer containing at least two epoxy groups and comprise at least one selected from the group consisting of bisphenol-based, aminophenol-based, siloxane-based, and alicyclic epoxy resins.

Preferably, the second monomer may serve as a curing agent containing sulfur and comprise at least one selected from the group consisting of 4-aminophenyl disulfide, 3,3′-dihydroxydiphenyl disulfide, and 4-(2-hydroxyethoxy)phenyl disulfide.

The second monomer may be represented by the following chemical formula 1, 2, or 3,

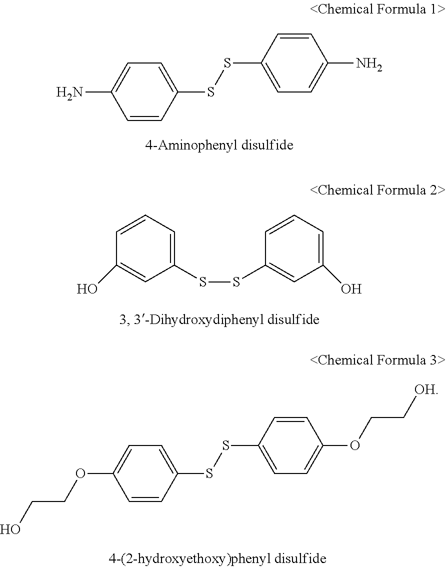 [SMILES: Nc1ccc(SSc2ccc(N)cc2)cc1 ; Oc1cccc(SSc2cccc(O)c2)c1 ; OCCOc1ccc(SSc2ccc(OCCO)cc2)cc1]

The step of mixing the first and second monomers and heating the mixture is performed, preferably at a temperature of 95 to 105° C. for 5 to 15 minutes, and more preferably at a temperature of 100° C. for 10 minutes.

Preferably, the step of placing the heated mixture into a preheated mold includes preheating the mold to 100° C.

The step of degassing the mixture placed in the mold through vacuum substitution is performed by degassing through vacuum substitution, preferably for 10 to 20 minutes, and more preferably for 15 minutes.

The step of heating the degassed mixture at an elevated temperature to obtain a cured polymer is performed preferably by heating at an elevated temperature of 140 to 160° C. for 9 to 11 hours to obtain a cured polymer, and more preferably by heating at an elevated temperature of 150° C. for 10 hours to obtain a cured polymer.

For the purpose of facilitating the understanding of the present invention, detailed explanations will be provided through examples below. However, it should be noted that the examples provided below are merely illustrative of the content of the present invention, and the scope of the present invention is not limited to the examples below. The examples of the present invention are provided to more fully explain the invention to those in the relevant industry with average knowledge, rather than to restrict the scope of the invention to the examples below.

### <Example>Synthesis of Polymer with UV-Responsive Self-Healing Function

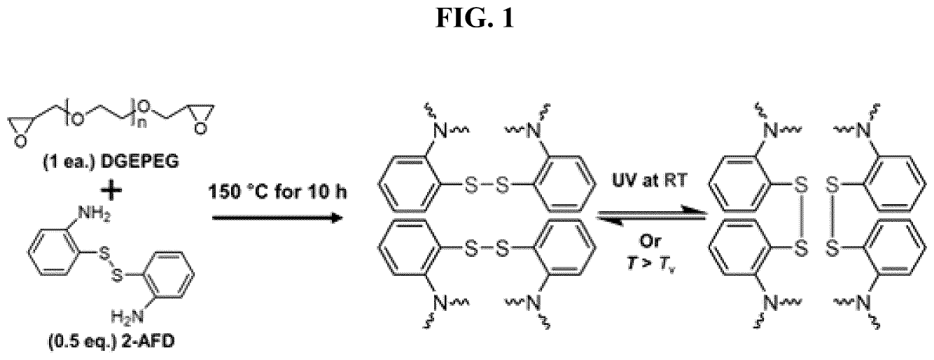

As shown in FIG. 1, a liquid-state epoxy monomer (DGEPEG) and an amine curing agent (2-AFD) having a melting point of 93° C. were stirred at 100° C. for 10 minutes to form a homogeneous mixture. The resulting mixture was poured into a mold preheated at 100° C. and subjected to vacuum substitution for 15 minutes for degassing. The degassed mixture was heated at an elevated temperature of 150° C. for 10 hours to obtain a cured network polymer through the epoxy-amine addition reaction.

### <Experimental Example 1>Curing of Polymer with UV-Responsive Self-Healing Function

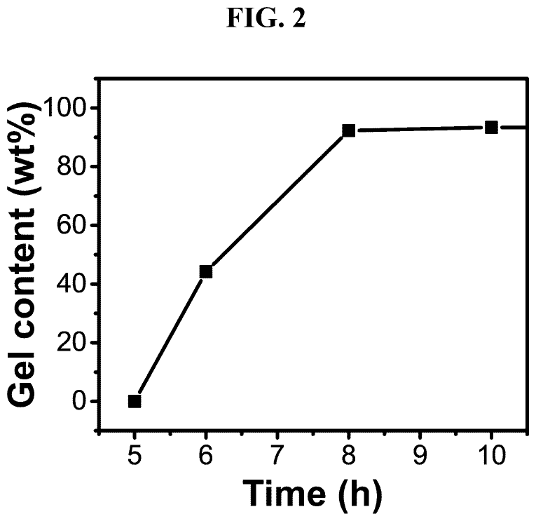

The polymer manufactured according to the Example was subjected to gel content analysis in order to assess the degree of curing at 150° C. over time, as shown in FIG. 2. Each polymer specimen at different curing times was weighed, immersed in THF (Tetrahydrofuran) solvent for one day, and then dried in a 60° C. oven for another day. Subsequent weight measurements revealed a sharp increase in gel fraction over time, reaching over 90% gel content after 8 hours and maintaining this level thereafter.

### <Experimental Example 2>ATR-FTIR Analysis

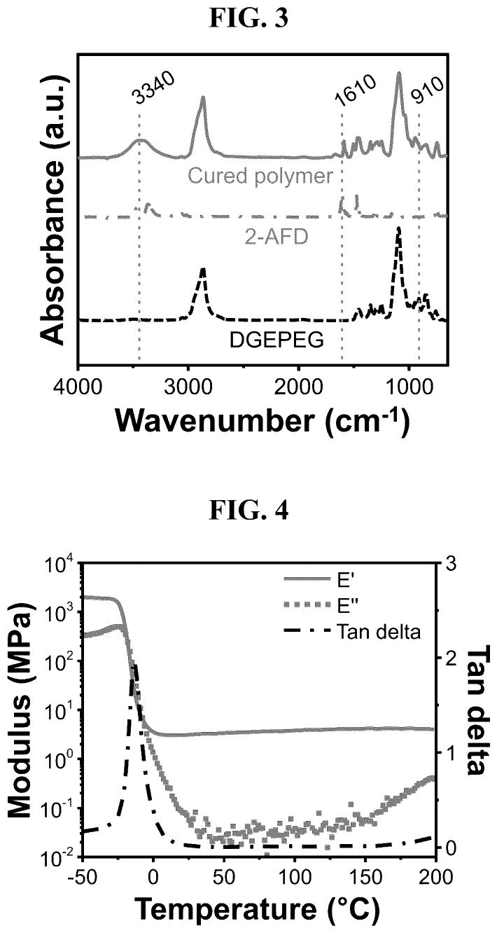

The polymer specimen cured at 150° C. for 10 hours according to the Example, the epoxy monomer (DGEPEG) and the amine curing agent (2-AFD) were analyzed using ATR-FTIR, as shown in FIG. 3. The cured polymer specimen showed a broad hydroxyl peak at around 3340 cm⁻¹ due to the hydroxyl groups formed by the epoxide ring-opening reaction. The bending peak of the primary amine (at about 1610 cm⁻¹), observed in the amine monomer, was absent in the cured polymer specimen, indicating the progression of the primary amine reaction. Furthermore, the disappearance of the epoxy peak (at around 910 cm⁻¹) from the epoxy monomer in the cured specimen suggested the occurrence of the epoxide ring-opening reaction. Therefore, the FT-IR analysis confirmed the complete progression of the epoxy-amine curing reaction.

### <Experimental Example 3>Analysis of Thermo-Mechanical Properties

The polymer specimen cured at 150° C. for 10 hours according to the Example was subjected to a thermo-mechanical property analysis using a rheometer in the temperature sweep mode, as shown in FIG. 4. Upon heating from −50° C., the cured polymer specimen showed a glass transition temperature (maximum tan delta) of about −13° C., accompanied by a sharp decrease in storage modulus. Subsequently, in the high-temperature range, the storage modulus exhibited a plateau, indicating the presence of a crosslinked polymer structure in the polymer.

### <Experimental Example 4>Analysis of Stress Relaxation Induced by UV Exposure at Ambient Temperature

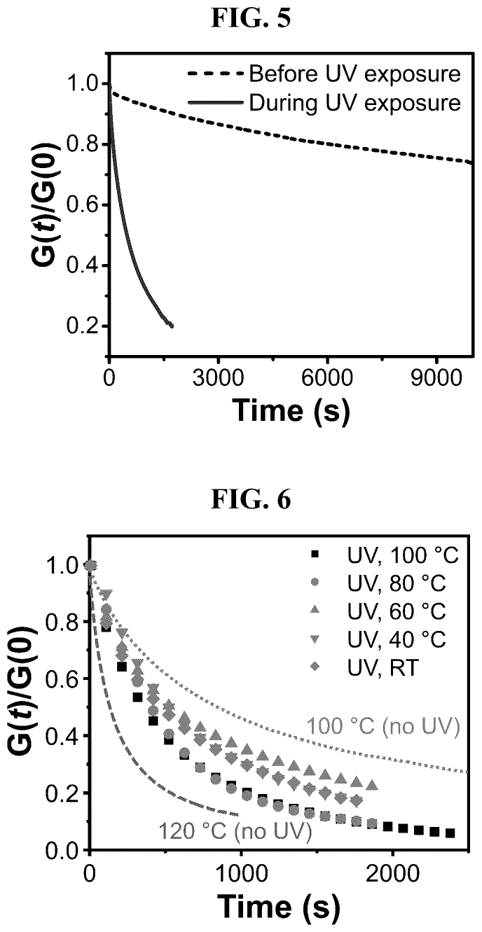

The polymer manufactured according to the Example was subjected to a stress relaxation analysis at ambient temperature, comparing the behavior of stress relaxation with and without UV exposure, as shown in FIG. 5. The polymer specimen, which previously exhibited a very slow stress relaxation at ambient temperature, showed a rapid stress relaxation when measured under UV exposure. The stress relaxation experiment conducted under UV exposure implicitly suggested the exchange reaction of aromatic disulfide activated by radiation exposure.

### <Experimental Example 5>Analysis of Stress-Relaxation with Temperature Variation

To investigate the influence of temperature, the polymer produced according to the Example was subjected to stress-relaxation experiments under UV exposure at various temperatures such as ambient temperature, 40° C., 60° C., 80° C., and 100° C., as shown in FIG. 6. The results revealed nearly constant relaxation behaviors regardless of the temperature. During the UV exposure, the stress-relaxation behavior results exhibited a similar stress-relaxation time to the results obtained without UV exposure at temperatures between 100° C. and 120° C. Therefore, UV exposure at ambient temperature led to a same exchange reaction rate as shown at the elevated temperatures of 100° C. to 120° C. without UV exposure.

### <Experimental Example 6>Repair and Reprocessing Through UV Exposure at Ambient Temperature

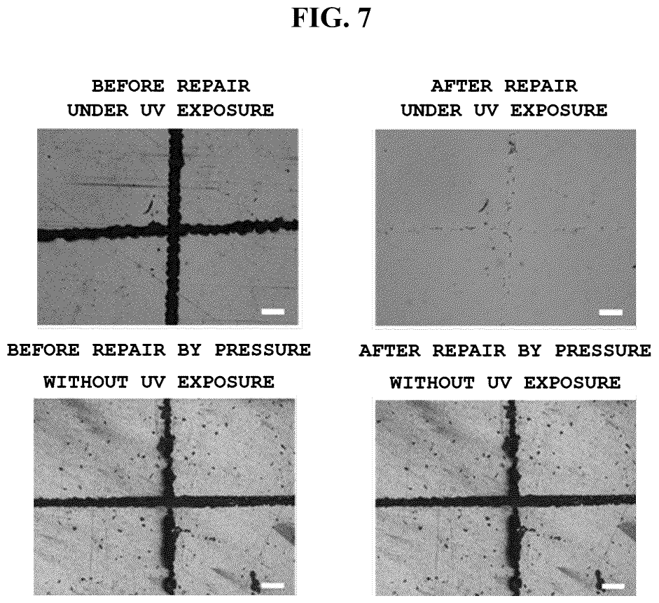

A film-shaped polymer specimen fabricated according to the Example was scratched with a razor blade. A thin quartz plate capable of light transmission was placed above and below the polymer specimen, and slight pressure was applied using a clip. UV radiation at a wavelength of 254 nm with an intensity of 30 mW/cm² was then applied to the fixed polymer specimen for 10 minutes. The light energy during this UV exposure was 18 J/cm². As depicted in FIG. 7, complete recovery of the scratch was observed after UV exposure at ambient temperature. However, the polymer specimen subjected only to pressure without UV exposure showed no recovery even after 2 hours. Therefore, it can be inferred that the recovery of the scratch was a result of the fluidity induced by UV exposure.

The detailed description of certain aspects of the present invention above is merely a desirable embodiment for those skilled in the art with common knowledge in the field, and it is evident that such specific disclosure is not limiting the scope of the invention. Therefore, the substantive scope of the present invention shall be defined by the attached claims and their equivalents. The scope of the invention is expressed in the appended claims, and any variations or modified forms derived from the meaning and scope of the claims and the concept of equivalence should be interpreted as included within the scope of the invention.

What is claimed is:

1. A polymer with a UV-responsive self-healing function, comprising:
a first monomer containing at least two epoxy groups; and
a second monomer serving as a curing agent,
wherein the first and second monomers are combined to enable a dynamic disulfide exchange reaction, allowing for self-healing.

2. The polymer according to claim 1, wherein the first monomer comprises at least one selected from the group consisting of bisphenol-based, aminophenol-based, siloxane-based, and alicyclic epoxy resins.

3. The polymer according to claim 1, wherein the second monomer serves as a curing agent containing sulfur and comprises at least one selected from the group consisting of 4-aminophenyl disulfide, 3,3′-dihydroxydiphenyl disulfide, and 4-(2-hydroxyethoxy)phenyl disulfide.

4. The polymer according to claim 1, wherein the second monomer is represented by the following Chemical Formula 1, 2 or 3,

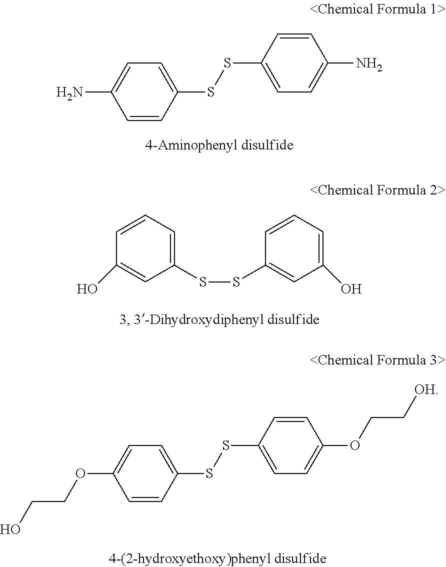 [SMILES: Nc1ccc(SSc2ccc(N)cc2)cc1 ; Oc1cccc(SSc2cccc(O)c2)c1 ; OCCOc1ccc(SSc2ccc(OCCO)cc2)cc1]

5. The polymer according to claim 1, wherein the polymer is capable of self-healing through a dynamic disulfide exchange reaction induced by exposure to UV radiation when damaged even after curing.

6. The polymer according to claim 5, wherein the UV radiation has a wavelength of 250 to 260 nm.

7. The polymer according to claim 5, wherein the exposure to UV radiation is conducted by irradiating UV radiation with an intensity of 20 to 40 mW/cm² for 5 to 15 minutes at ambient temperature.

8. A method for manufacturing a polymer with a UV-responsive self-healing function, comprising:
mixing a first monomer and a second monomer and heating the mixture;
placing the heated mixture into a preheated mold;
degassing the mixture placed in the mold through vacuum substitution; and
heating the degassed mixture at an elevated temperature to obtain a cured polymer.

9. The method according to claim 8, wherein the first monomer is a monomer containing at least two epoxy groups and comprises at least one selected from the group consisting of bisphenol-based, aminophenol-based, siloxane-based, and alicyclic epoxy resins.

10. The method according to claim 8, wherein the second monomer serves as a curing agent containing sulfur and comprises at least one selected from the group consisting of 4-aminophenyl disulfide, 3,3′-dihydroxydiphenyl disulfide, and 4-(2-hydroxyethoxy)phenyl disulfide.

11. The method according to claim 8, wherein the second monomer is represented by the following chemical formula 1, 2, or 3,

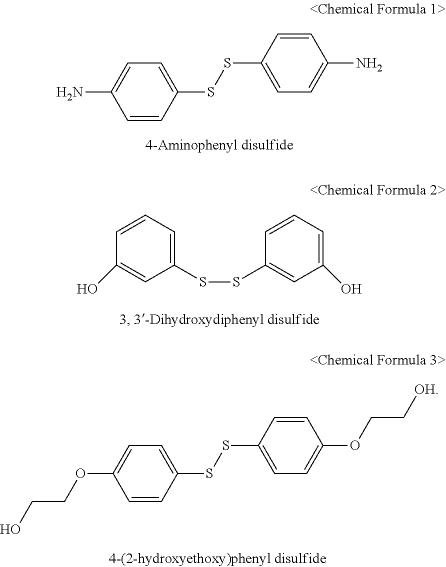 [SMILES: Nc1ccc(SSc2ccc(N)cc2)cc1 ; Oc1cccc(SSc2cccc(O)c2)c1 ; OCCOc1ccc(SSc2ccc(OCCO)cc2)cc1]

12. The method according to claim 8, wherein the step of mixing the first and second monomers and heating the mixture is performed at a temperature of 95 to 105° C. for 5 to 15 minutes.

13. The method according to claim 8, wherein the step of degassing the mixture placed in the mold through vacuum substitution is degassing through vacuum substitution for 10 to 20 minutes.

14. The method according to claim 8, wherein the step of heating the degassed mixture at an elevated temperature to obtain a cured polymer is heating the mixture at an elevated temperature of 140 to 160° C. for 9 to 11 hours to obtain a cured polymer.
